(19) United States
(12) Patent Application Publication
(10) Pub. No.: US 2015/0002978 A1
(43) Pub. Date: Jan. 1, 2015

(54) POWER OVER ETHERNET SURGE PROTECTOR

(71) Applicant: Lauro Pomasan, Metuchen, NJ (US)

(72) Inventor: Lauro Pomasan, Metuchen, NJ (US)

(21) Appl. No.: 13/931,976

(22) Filed: Jun. 30, 2013

(51) Int. Cl. H02H 9/00

(52) U.S. Cl. CPC H02H 9/005
USPC 361/119

(57) ABSTRACT

An electrical surge protection device can provide surge protection and electrostatic discharge protection to power over Ethernet (PoE) ports and devices attached thereto. The PoE surge protection device includes connectors on each side thereof with a surge protection circuit disposed between the connectors. The surge protection circuit offers low capacitance while protection equipment connected to the device. The surge protection device can be, for example, mounted on a patch panel to protect equipment connected thereto.

### BACKGROUND OF THE INVENTION

The present invention relates to power over Ethernet (PoE) surge protectors and, more particularly, to a device that provides the PoE ports with surge protection, electrostatic discharge (ESD) protection and low capacitance.

The growth of local and wide area networks based on Ethernet technology has been an important driver for cabling offices and homes with structured cabling systems having multiple twisted wire pairs. Many networks, such as local and wide area networks (LAN/WAN), are used to carry and distribute data communication signals between devices. Various network components include hubs, switches, routers, bridges and peripheral devices, such as printers, data servers, desktop personal computers (PCs), portable PCs and personal data assistants (PDAs) equipped with network interface cards. Devices that connect to the network structure use power to enable operation. Power of the devices may be supplied by either an internal or an external power supply such as batteries or an AC power via a connection to an electrical outlet.

Some network solutions can distribute power over the network in combination with data communications. Power distribution over a network consolidates power and data communications over a single network connection to reduce installation costs, ensures power to network elements in the event of a traditional power failure, and enables reduction in the number of power cables, AC to DC adapters, and/or AC power supplies. Power distributed over a network, such as an Ethernet network, may function as an uninterruptible power supply (UPS) to components or devices that normally would be powered using a dedicated UPS.

Distribution of power over Ethernet (PoE) network connections is, in part, governed by the Institute of Electrical and Electronics Engineers (IEEE) Standard 802.3 and other relevant standards. Power can be delivered to a powered device (PD) either directly from the switch/hub, known as an endpoint power sourcing equipment (PSE), or alternatively via a midspan PSE. Unfortunately, no provision has been made in the above standard for controlling surges and electrostatic discharges within the power distributed over the Ethernet.

As can be seen, there is a need for a low capacitance apparatus for protecting PoE ports from surges and electrostatic discharge.

### SUMMARY OF THE INVENTION

In one aspect of the present invention, a pass through surge protector for power over Ethernet applications comprises a first connector for receiving data signals and power signals; a second connector for outputting protected data signals and protected power signals to equipment; a first chipset disposed in series between the data signals and the protected data signals, the first chipset having low capacitance transient voltage suppression array diodes; and a second chipset disposed between the power signals and the protected power signals, the second chipset includes a transient voltage suppressor diode.

In another aspect of the present invention, a method for providing surge and electrostatic discharge protection in a power over Ethernet application comprises receiving an Ethernet cable into a first connector, the Ethernet cable carrying data signals and power signals; outputting protected data signals and protected power signals to equipment; passing the data signals through a first chipset disposed in series between the data signals and the protected data signals, the first chipset having low capacitance transient voltage suppression array diodes; and passing the power signals through a second chipset disposed between the power signals and the protected power signals, the second chipset includes a transient voltage suppressor diode.

These and other features, aspects and advantages of the present invention will become better understood with reference to the following drawings, description and claims.

### BRIEF DESCRIPTION OF THE DRAWINGS

FIG. 1 is a perspective view of a power over Ethernet surge protection device according to an exemplary embodiment of the present invention;

FIG. 2 is a perspective view of the PoE surge protection device of FIG. 1 with the cap illustrated in phantom for clarity;

FIG. 3 is a perspective view of the PoE surge protection device of FIG. 1 with the cap and body illustrated in phantom for clarity; and

FIG. 4 is an electrical schematic diagram of the PoE surge protection device of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical surge protection device that can provide surge protection and electrostatic discharge protection to power over Ethernet ports and devices attached thereto. The PoE surge protection device includes connectors on each side thereof with a surge protection circuit disposed between the connectors. The surge protection circuit offers low capacitance while protection equipment connected to the device. The surge protection device can be, for example, mounted on a patch panel to protect equipment connected thereto.

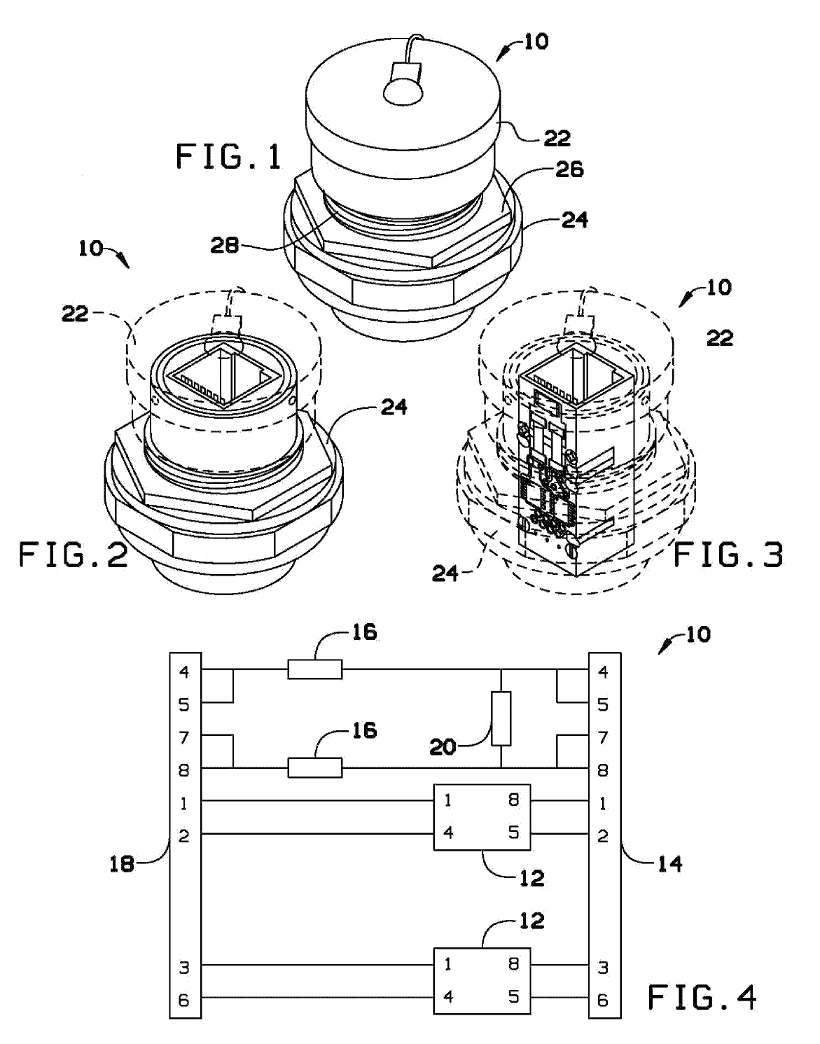

Referring now to FIGS. 1 through 4, a PoE device 10 can include a first connector 14 disposed on and accessible from one end of the device 10. A second connector 18 can be disposed on and accessible from a second, opposite end of the device 10. A cap 22 can fit over the first connector 14 when the device 10 is not in use. A body portion 24 of the device 10 can be designed to allow the device 10 to be mounted in a desired location, such as, for example, a patch panel. The body portion 24 can include, for example, a threaded portion 26 and a nut member 28 for mounting the device 10.

In some embodiments, the first connector 14 can be a RJ-45 connector having eight connection points. The first connector 14 could be, for example, a Molex model number 43860-0004 connector. The second connector 18 can also be a RJ-45 connector having eight connection points. The second connector 18 could be, for example, a TE Connectivity/AMP model number 5406299-1 connector.

Referring now to FIG. 4, the circuit design can include a first chip 12 having a combination of low capacitance transient voltage suppression (TVS) array diodes for data pairs. Typically two of the first chips 12 can be used for each set of data pairs (typically a first data pair will be on pins 1 and 2 of the connectors 14, 18 and the second data pair will be on pins 3 and 6 of the connectors 14, 18). The first chips 12 can be, for example, a Littelfuse® SP03A-3.3 chipset of a Littelfuse® LC03-3.3 chipset.

The circuit design can include a second chip 20 for surge protection over the power pairs. Typically, the power pairs will be between pins 4/5 and 7/8 of the connectors 14, 18. The second chip 20 can be a transient voltage suppressor diode, such as a Littelfuse® SMBJ58CA bidirectional diode. As shown in FIG. 4, each of the power pairs can include a fuse 16 disposed therein, such as a ceramic fuse, such as a F1 04611.25ER fuse.

It should be understood, of course, that the foregoing relates to exemplary embodiments of the invention and that modifications may be made without departing from the spirit and scope of the invention as set forth in the following claims.

What is claimed is:

1. A pass through surge protector for power over Ethernet applications, comprising:
a first connector for receiving data signals and power signals;
a second connector for outputting protected data signals and protected power signals to equipment;
a first chipset disposed in series between the data signals and the protected data signals, the first chipset having low capacitance transient voltage suppression array diodes; and
a second chipset disposed between the power signals and the protected power signals, the second chipset includes a transient voltage suppressor diode.

2. The pass through surge protector of claim 1, further comprising a fuse disposed along each of the power signals.

3. The pass through surge protector of claim 1, further comprising a cap covering the first connector.

4. The pass through surge protector of claim 1, further comprising a body member having means for mounting the pass through surge protector to a structure.

5. The pass through surge protector of claim 4, wherein the means for mounting the pass through surge protector includes a nut threaded on a threaded member of the body member.

6. The pass through surge protector of claim 1, wherein the first connector and the second connector are RJ-45 Ethernet connectors.

7. A method for providing surge and electrostatic discharge protection in a power over Ethernet application, the method comprising:
receiving an Ethernet cable into a first connector, the Ethernet cable carrying data signals and power signals;
outputting protected data signals and protected power signals to equipment;
passing the data signals through a first chipset disposed in series between the data signals and the protected data signals, the first chipset having low capacitance transient voltage suppression array diodes; and
passing the power signals through a second chipset disposed between the power signals and the protected power signals, the second chipset includes a transient voltage suppressor diode.

8. The method of claim 7, further comprising disposing a fuse along each of the power signals.

9. The method of claim 7, further comprising covering the first connector with a cap when not in use.

10. The method of claim 7, further comprising mounting a body member housing the first connector, the second connector, first chipset and second chipset to a structure.
